(19) United States
(12) Patent Application Publication
(10) Pub. No.: US 2008/0078652 A1
(43) Pub. Date: Apr. 3, 2008

(54) Apparatus and Method for Loading Cartons on Carton Forming Machines

(76) Inventors: David Wayne Arnett, Howell, MI (US); Russell Paul Miller, Fowlerville, MI (US); Kenneth Archie Poublon, Taylor, MI (US); Eric Thomas Sanders, Wayne, MI (US)

Correspondence Address: CALFEE HALTER & GRISWOLD, LLP, 800 SUPERIOR AVENUE, SUITE 1400, CLEVELAND, OH, 44114, US

(21) Appl. No.: 11/792,989

(22) PCT Filed: Dec. 14, 2005
(86) PCT No.: PCT/GB05/04822

§ 371 Date: Oct. 5, 2007

Related U.S. Application Data
(60) Provisional application No. 60/635,910, filed on Dec. 14, 2004.

(51) Int. Cl. B65G 43/02; B65G 43/00; B65G 49/00

(52) U.S. Cl. 198/341.01; 198/346.2; 198/502.4; 198/617

(57) ABSTRACT

An apparatus (10) loads partially-formed open-ended cartons (12) onto respective mandrels (14) of a turret (16) that indexes cartons through work stations. A conveyor (18) propels the partially formed cartons (12) along a load path (20) and loads them onto respective mandrels (14). A loader guide guides the partially formed cartons (12) along the load path (20) and maintains them in axial alignment with the respective mandrels (14). A loading pusher (24) carried by the conveyor (18) engages successive partially formed cartons and propels them along the loader guide and onto the mandrels (14). A controller (30) commands a loading servo motor (28) to advance the conveyor (18) and transport each partially formed carton (12) along the load path (20) and into a delivered position on one of the mandrels (14) and then to reverse the conveyor (18) momentarily before the turret (16) indexes. The advancing, withdrawing, and indexing steps are repeated for second and subsequent partially formed cartons (12) and mandrels (14).

This invention relates generally to a method and apparatus for delivering an article to a receiver, for example for loading a series of partially-formed paperboard cartons in open-ended, rectilinear tube configurations, onto respective arms or mandrels of a rotating turret upon which one end of each carton is then sequentially folded, closed, and sealed as the turret indexes the cartons through various circumferentially-spaced stations in a machine for forming cartons from carton blanks.

Carton forming machines having turrets for indexing partially-formed, open-ended cartons through end folding, closing, and sealing stations are well-known in the art. For example, a carton folding, filling, and sealing machine known as the ELOPAK® P-S50 includes such a turret. The ELOPAK® P-S50 also includes a carton blank magazine that holds a plurality of paperboard carton blanks in flattened form and a feeder that includes suction cups to engage the carton blanks in the magazine and pull them open into open-ended rectilinear tube form. The turret has a plurality of radially-extending arms or mandrels. Each mandrel is shaped to axially receive a partially-formed, open-ended, paperboard carton. The turret is rotatably supported and configured to rotate the mandrels through a plurality of circumferentially-spaced work stations where successive operations are performed to close and seal the bottom ends of cartons supported on the mandrels.

A turret loading device of the ELOPAK® P-S50 includes a loader guide that receives cartons in open-ended rectilinear tube form from the feeder and deposits them over the turret mandrels for transport through the bottom-forming work stations. The turret loading device includes an endless conveyor chain supported on chain guides between an upstream sprocket and a downstream sprocket. A loader motor drives the chain continuously in one sense at a constant velocity by turning the downstream sprocket. The turret loading device of the P-S50 also includes plastics loading fingers that are supported at spaced locations along the chain and extend radially outward from along the chain path in positions where they engage trailing edges of the open-ended cartons to propel the cartons along loader guide rails and onto the respective turret mandrels.

The P-S50 machine requires a highly accurate positional relationship to exist between the loading finger and the trailing edge of the carton, because the finger has to slide accurately past that trailing edge; if the finger leaves contact with that edge too late, there is a risk of damage to that edge, but if the finger leaves contact with that edge too early, the carton is not fully loaded onto the mandrel or rebounds. If this relationship is slightly inaccurate, time-consuming mechanical adjustment, or even reworking of parts, sometimes by trial and error, may be necessary.

As each carton reaches a mounted position on one of the mandrels, the finger pushing that carton continues downward in an arc as the chain carries that finger around the downstream sprocket. Since this downward arcing motion of each finger around the downstream sprocket could damage the trailing edges of the cartons as the chain carries the fingers forward and downward, the fingers are carefully shaped to endeavour to preclude such damage.

According to one aspect of the present invention, there is provided apparatus comprising a loading device including a loader for forwarding an article, a receiving device including a receiver for receiving said article delivered thereto by said loader, an advancing device arranged to advance said loader on an endless path a driving device drivingly connected to said receiving device for advancing said receiver along a second path extending into the region of a portion of said endless path at which said loader delivers said article to said receiver, said advancing device being arranged to reverse said loader momentarily out of said region immediately following delivery of said article to said receiver.

According to another aspect of the present invention, there is provided a method comprising advancing a loader along an endless path into a region of which a second path extends and causing said loader to deliver an article to a receiver located on said second path at said region, momentarily reversing said loader out of said region immediately following the delivery of said article to said receiver, and advancing said receiver along said second path.

Owing to the present invention it is possible to avoid interference between the loader and an article on the receiver (or the receiver itself) and thereby to avoid consequential damage.

In particular, a highly accurate positional relationship between the carton and the loader may not be so necessary, whilst by using a brushless servo motor with pulse train command and encoded feedback it is nevertheless possible to attain a highly accurate positional relationship between the carton and the loader.

Thus, according to a third aspect of the present invention, there is provided apparatus comprising a loading device including a loader for forwarding an article, a receiving device including a receiver for receiving said article delivered thereto by said loader, an advancing device arranged to advance said loader on an endless path a driving device drivingly connected to said receiving device for advancing said receiver along a second path extending into the region of a portion of said endless path at which said loader delivers said article to said receiver, and a controller connected to said advancing device and said driving device for controlling said advancing device and said driving device said advancing device being a brushless servo motor with pulse train command by said controller and with encoded feedback to said controller as to the position of said brushless servo motor.

In a preferred embodiment of the invention, a carton forming machine turret loading apparatus is provided for loading the articles, which are partially-formed open-ended cartons, onto respective receivers, which are mandrels of a rotatable turret that indexes each carton through circumferentially-spaced work stations. The loading device is a conveyor arranged to propel a series of longitudinally-oriented cartons, in open-ended rectilinear tube form, along a load path and to load the cartons onto respective turret mandrels when those mandrels are axially-aligned with the load path. The turret loading apparatus also includes a loader guide arranged to guide cartons in open-ended rectilinear tube form axially along the load path and to maintain the cartons in axial alignment with respective turret mandrels. The advancing device is a loading servo motor drivingly connected to the conveyor and there are loaders, in the form of loading pushers carried by the conveyor, to engage successive cartons and propel them along the loader guide and onto respective mandrels. The apparatus includes a controller arranged to command the loading servo motor to advance the conveyor and transport each carton along the load path and into a fully mounted position on a mandrel and then to reverse the conveyor momentarily before the turret indexes. This momentary reversal is to prevent the loading pusher from interfering with the subsequent indexing of a carton by the turret or damaging a carton. The reversal also allows for a simpler design of loading pusher, because the pusher need not be designed to slip past the edge of the carton without damaging the carton as it would if mounted on a continuous, i.e. non-reversing, conveyor. Also, because the apparatus is capable of fully withdrawing the pusher, the apparatus can use the pusher to position each carton positively and accurately on its intended mandrel pusher.

The method of the preferred embodiment is of loading partially-formed open-ended cartons onto respective mandrels of an indexing turret of a turret loading apparatus provided adjacent a rotatably supported carton forming machine turret, where the turret loading apparatus includes a loader guide and a conveyor. A first carton is provided in open-ended rectilinear tube form on the loader guide. The conveyor is then advanced until a first loading pusher carried by the conveyor has engaged and propelled the first carton along a load path and onto a first turret mandrel. The first loading pusher is then withdrawn by reversing the conveyor. The turret is then indexed until the turret presents a second turret mandrel in alignment with the conveyor.

In order that the invention may be clearly and completely disclosed, reference will now be made, by way of example, to the accompanying drawings, in which:

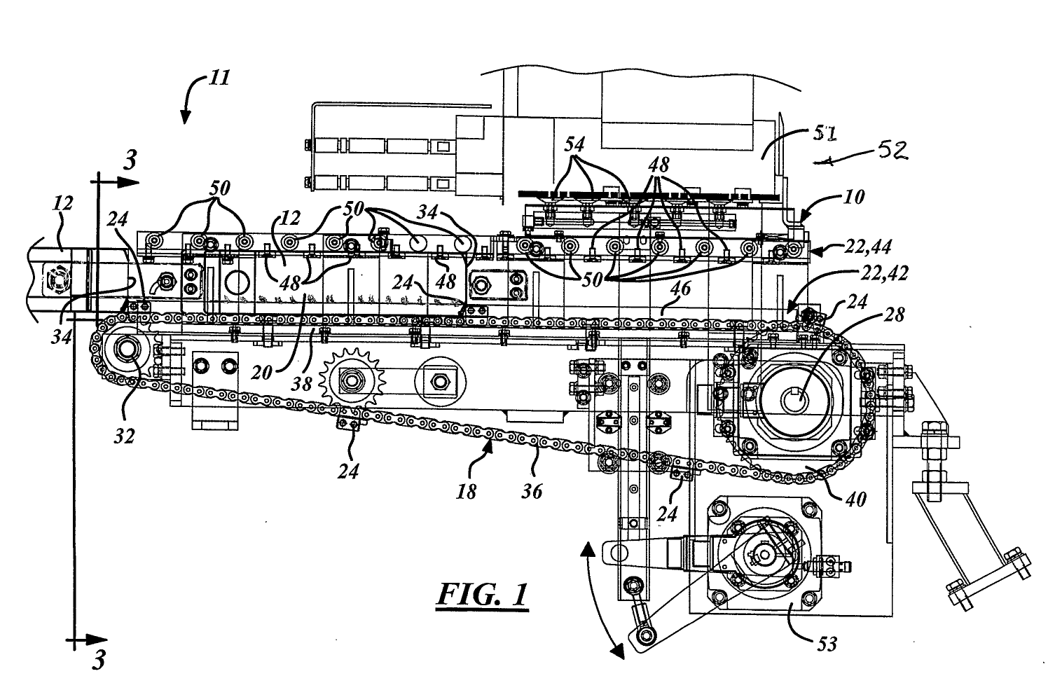

FIG. 1 is a side elevation of a turret loading apparatus installed adjacent a turret of a carton form-fill-seal machine;

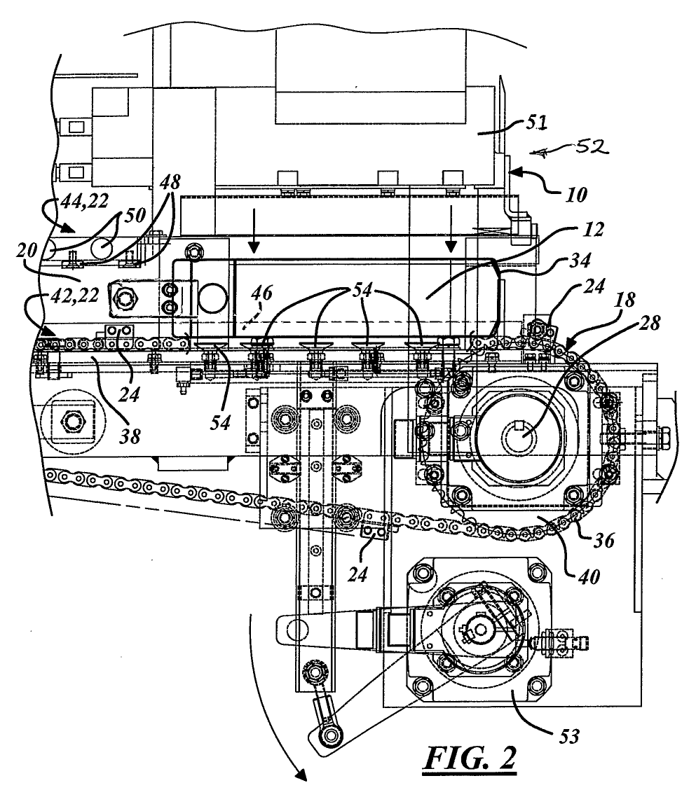

FIG. 2 a magnified partial view of the right-hand end of FIG. 1, but with a conveyor chain of the apparatus broken away to show a rack of vacuum cups at a lowermost limit of its travel;

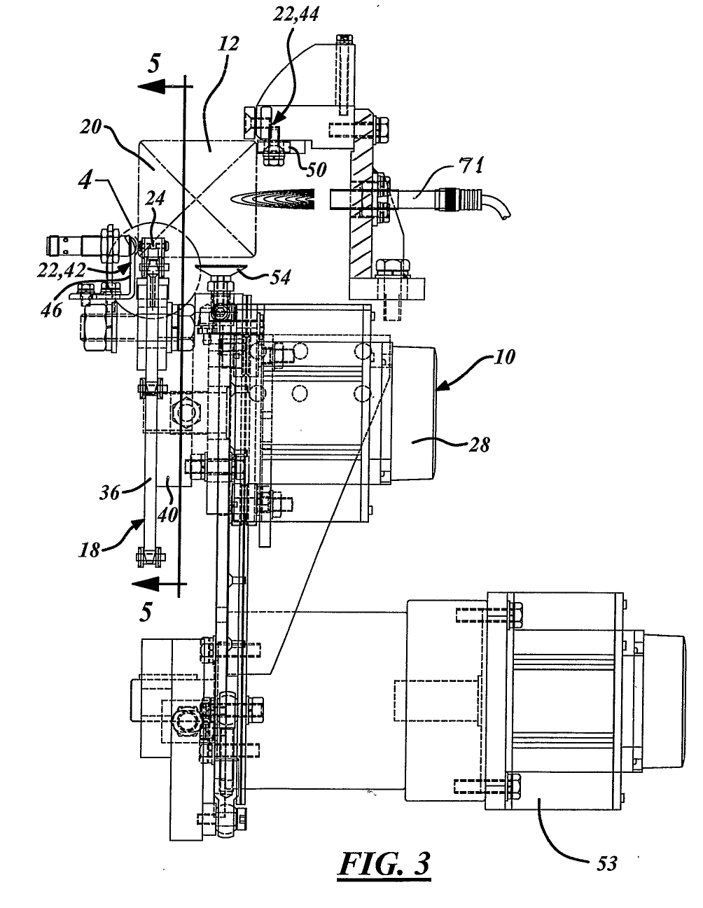

FIG. 3 is an end elevation of the turret loading apparatus taken along line 3-3 of FIG. 1;

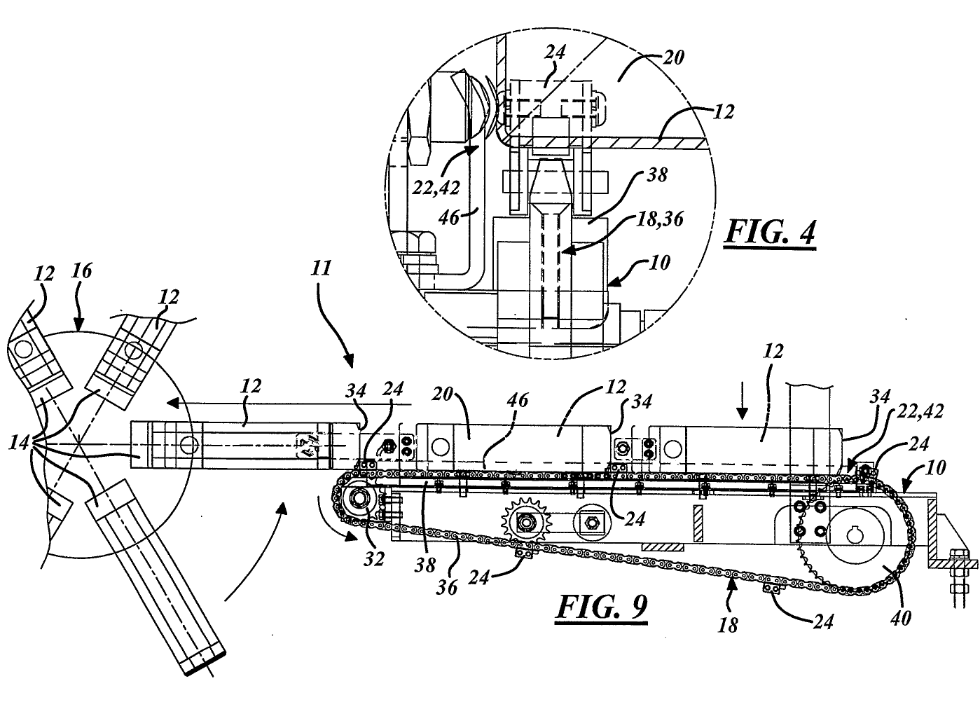

FIG. 4 is a magnified detail of the region circled 4 in FIG. 3;

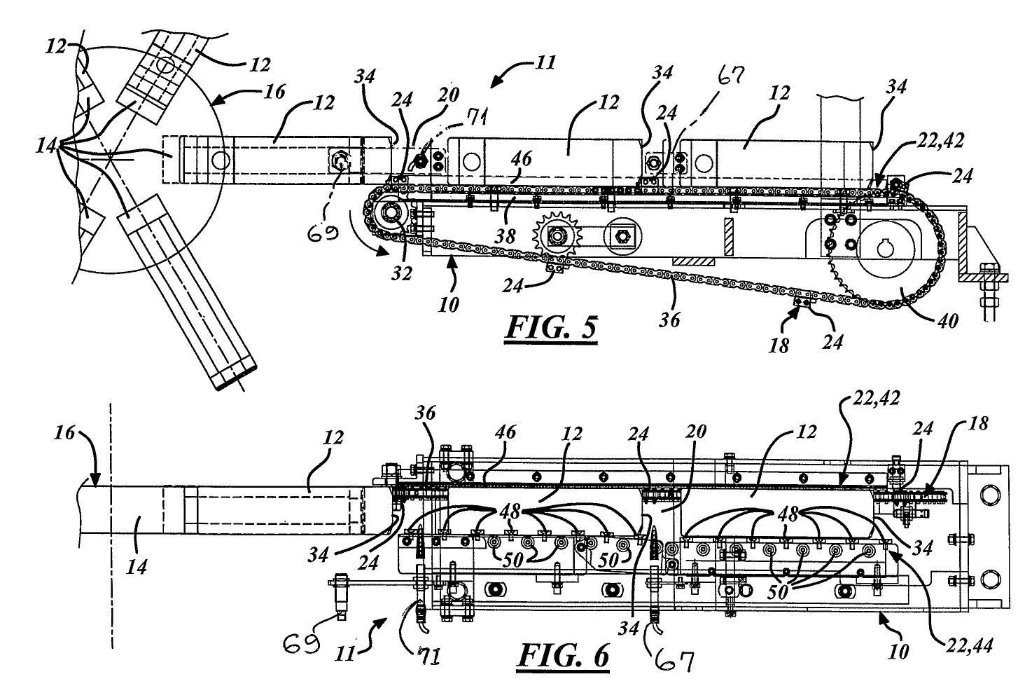

FIG. 5 is a longitudinal sectional view of the apparatus taken along line 5-5 of FIG. 3, but also illustrating in dot-dash lines certain items located to the right of that line, and showing a conveyor of the apparatus advancing and loading a carton onto a turret mandrel;

FIG. 6 is a top plan of the apparatus according to FIG. 5;

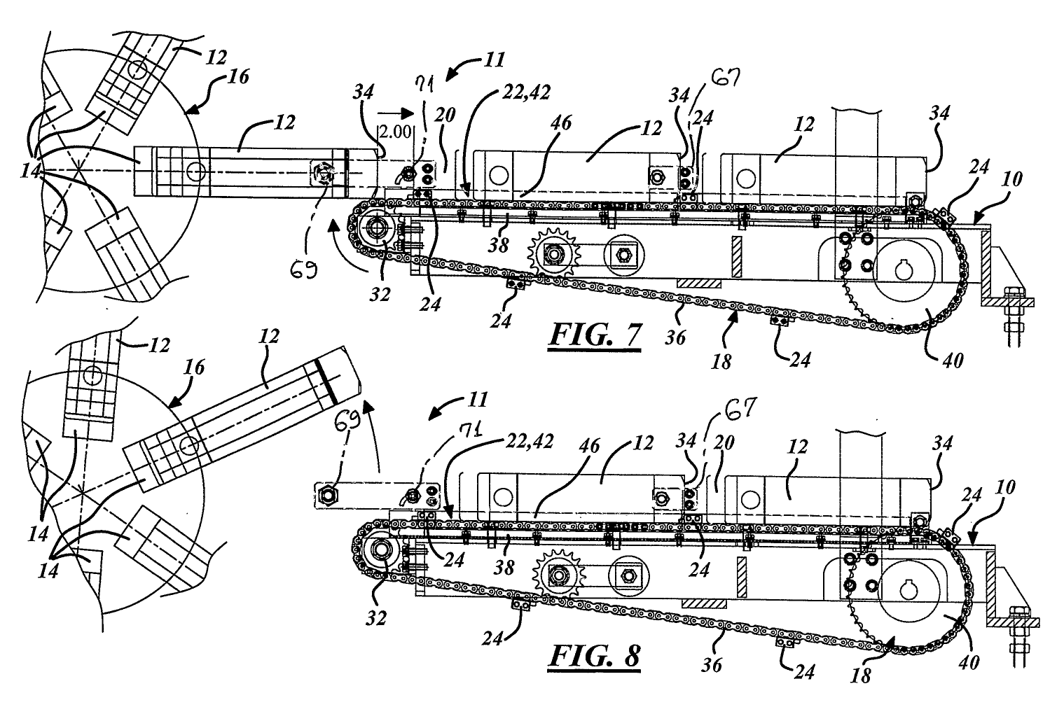

FIG. 7 is a view similar to FIG. 5, but showing the conveyor having been reversed after loading the carton onto the turret mandrel;

FIG. 8 is a view similar to FIG. 5, but showing the turret being indexed with the conveyor having been reversed;

FIG. 9 is a view similar to FIG. 5, but showing the conveyor advancing another carton onto a turret mandrel that has just been indexed into a position to receive the other carton;

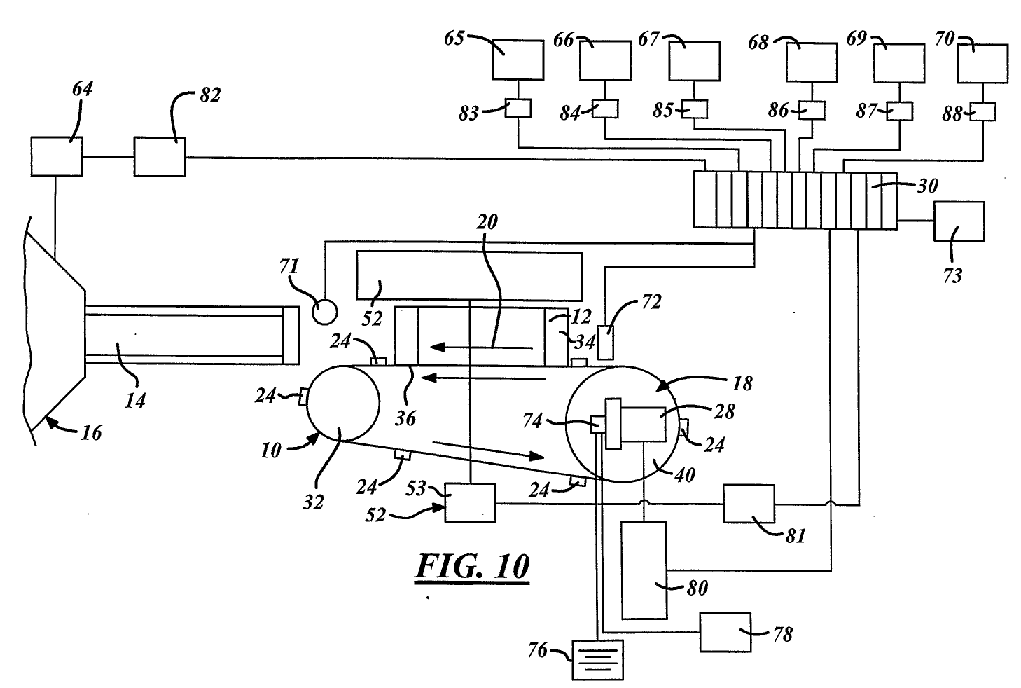

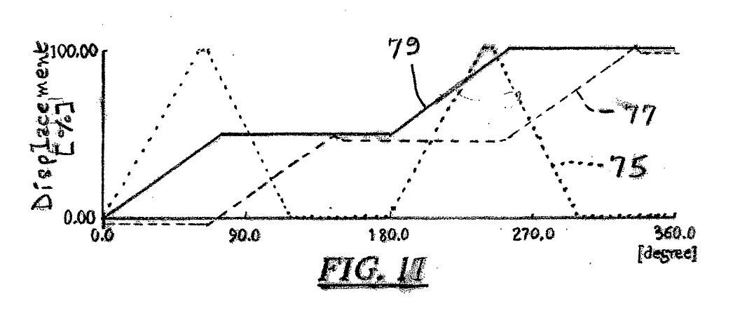

FIG. 10 is a schematic block diagram showing, inter alia, a controller, servo motors, and sensors of the apparatus; and

FIG. 11 is a diagram showing graphs depicting profiles of an electronic feeding cam and an electronic loading cam of the turret loading apparatus and of an electronic turret cam of the machine incorporating the turret loading apparatus.

Referring to the drawings, a carton form-fill-seal machine turret loading apparatus is indicated at 10 in FIGS. 1 to 10 and is shown in FIGS. 1 and 5 to 10 as being installed in the machine generally indicated at 11. The apparatus 10 loads partially-formed, open-ended plastics-coated paperboard cartons 12 in rectilinear tube form onto respective radially-extending arms or mandrels 14 of an indexing turret 16, as shown in FIGS. 5 to 10, which rotates about a horizontal axis and upon which one end of each carton 12 is sequentially folded, closed, and sealed as the turret 16 indexes the carton through various circumferentially-spaced work stations in the machine 11 which forms the cartons 12 from flat carton sleeves.

The apparatus 10 includes a loading conveyor, generally indicated at 18, that propels longitudinally-oriented cartons 12 in open-ended rectilinear tube form serially along a load path 20 and loads the cartons 12 onto respective turret mandrels 14 after each of the mandrels 14 has been rotationally indexed into a position axially aligned with the load path 20. The apparatus 10 also includes a loader guide, generally indicated at 22 in FIGS. 1 to 8, that guides the partially formed cartons 12 axially along the load path 20 and maintains the cartons 12 in axial alignment with respective turret mandrels 14. Five loading pushers 24 in the form of plastics chain lugs 24 are carried by the conveyor 18 at spaced positions along the conveyor to engage successive cartons 12 and propel them along the load path 20 and onto respective turret mandrels 14. A loading motor 28, in the present example a Mitsubishi HC-SF52 servo motor, is drivingly connected to the conveyor 18 as is best shown in FIG. 3.

Referring to FIG. 10, a controller 30 in the form of a programmable logic controller (PLC) 30 incorporates a motion central processing unit (CPU) (Mitsubishi Q173CPUN) and commands the motor 28, according to an electronic cam profile, to transport each carton 12 along the load path 20 and into a mounted position on a turret mandrel 14, as shown in FIGS. 5 and 6. Then, as shown in FIG. 7, the PLC 30 commands the motor 28 to reverse the conveyor 18 a short distance before the turret 16 indexes. The reversal distance, approximately 3 to 5 mm. in the present example, is sufficient to prevent the loading pusher 24 that propelled the carton 12 onto the mandrel 14 from interfering with the subsequent indexing of the carton 12 by the turret 16 and to prevent any associated damage to the carton 12. In other words, once each carton 12 has reached a fully mounted position on one of the mandrels 14, the pusher 24 pushing that carton 12 is retracted a short distance by reversing the conveyor 18, so that the turret 16 can index the loaded carton 12 out of the way before the conveyor 18 is again advanced. This reversal avoids damage to trailing edges 34 of the cartons 12 as the conveyor 18 carries the pushers 24 forward and downward, obviating the need to shape the pushers 24 specially to preclude such damage. The reversal also allows the pusher 24 to deposit its carton 12 fully and positively in its respective fully mounted position on its mandrel 14 before the pusher 24 is subsequently moved out of the way through conveyor reversal. When the conveyor 18 is advanced again, it carries the pusher 24 through a downward arc as the conveyor 18 carries that pusher 24 around a downstream sprocket 32.

The use, to advance the conveyor 18, of a brushless servo motor 28 with pulse train command and with encoded position feedback allows the conveyor more accurately to position the cartons 12 on the mandrels 14. This is because such a servo motor can move almost any practically desired number of pulses, in either direction, over almost any practically desired distance, or for almost any practically desired period of time, at almost any practically desired velocity, and with almost any practically desired degree of acceleration that the PLC 30 directs. A Mitsubishi HC-SF52 servo motor, for example, has 131,072 pulses or positions for each 360 degrees of rotation.

The conveyor 18 includes a chain loop 36 which is carried on an upstream sprocket 40 and the downstream sprocket 32 and an upper run of which is supported on chain guides 38 between those sprockets. The motor 28 is drivingly connected to the upstream sprocket 40. The plastics loading pushers 24 are carried at spaced locations along, and extend radially outward from, the conveyor chain 36 in respective positions to engage and propel successive, partially-formed, open-ended cartons 12 along the loader guide 22 and onto respective turret mandrels 14. Each pusher 24 comprises ultra-high molecular weight (UHMW) polyethylene.

As best shown in FIG. 3, the loader guide 22 includes two corner guides 42, 44 disposed in respective positions to guide diagonally opposite corners of each partially-formed open-ended carton 12 and to maintain the square cross-sectional rectilinear shape of each carton 12 during transport and turret loading. A lower corner guide 42 of the two corner guides 42, 44 includes the conveyor chain 36 and a side rail 46 positioned adjacent and parallel to the upper run of the conveyor chain 36. An upper corner guide 44 of the two corner guides 42, 44 includes a series of top rollers 48 supported adjacent a series of side rollers 50.

The corner guides 42, 44 receive cartons 12 in open-ended rectilinear tube form from a feeding device shown at 52 in FIGS. 1, 2, and 10. The feeding device includes a rack of vacuum cups 54 to engage each carton 12 in a carton magazine 51 as shown in FIG. 1. The feeding device 52 includes a feeding servo motor 53 that then pulls downward on the rack of vacuum cups 54 to pull each carton 12 open into open-ended rectilinear tube form while moving each carton 12 downward into the load path 20 and into the loader guide 22, as shown in FIG. 2. The corner guides 42, 44, because they engage diagonally-opposite corners of each carton 12, maintain the shape of the cartons 12 as the cartons 12 are transported along the load path 20 for loading on the turret mandrels 14.

In practice, the turret loading apparatus 10 is installed in the machine 11 adjacent a carton forming machine turret 16. A first carton 12 is provided in open-ended rectilinear tube form on the loader guide 22 of the apparatus 10 as shown in FIG. 2, and the conveyor 18 is advanced until a first loading pusher 24 carried by the conveyor 18 has engaged the first carton 12 and propelled it along the load path 20 defined by the loader guide 22 and onto a first turret mandrel 14, as shown in FIGS. 5 and 6. The first loading pusher 24 is then withdrawn by reversing the conveyor 18 as shown in FIG. 7. The turret 16 is then indexed, as shown in FIG. 8, until the turret 16 presents a second turret mandrel 14 in alignment with the conveyor 18, as shown in FIG. 9. The steps of advancing, withdrawing, and indexing are then repeated for second and subsequent loading pushers 24, cartons 12, and turret mandrels 14. The withdrawing step is included to allow the loading pusher 24 to locate the carton 12 more positively on the mandrel 14, to prevent the loading pusher 24 from interfering with the subsequent indexing of the carton 12 by the turret 16, and to prevent any associated carton damage.

The PLC 30 includes a virtual motor or virtual time axis—a software clock that runs continuously in time. The virtual time axis is the virtual master timer for synchronizing all operations of the machine 11 including the feeding device 52, the loading device 18-24, and the turret 16. It has a constant cycle speed that is scaled to 360 degrees of rotation.

The loading servo motor 28, the feeding servo motor 53, and seven further servos or servo axes 64-70 of the machine 11 are slaved to the virtual time axis of the PLC 30 via respective electronic cams programmed into the PLC 30. The seven other servos, shown at 64-70 in FIG. 10, are a turret servo motor 64 for controlling the indexing of the turret 16, a carton stripper servo motor 65 for stripping cartons off the turret mandrels 14, a transfer unit servo motor 66 for moving cartons from the stripper to a second conveyor (not shown), two filler servos 67 and 68 for controlling carton filler units (not shown), a carton lifter servo motor 69 for lifting cartons from the second carton conveyor of the machine into position for filling, and a conveyor servo motor 70 for controlling the indexing of the second conveyor. The servos 28, 53 and 64 to 70 are connected to the PLC 30 through respective servo amplifiers 80 to 88.

The PLC 30 includes an electronic cam for each of the two servo motors 28 and 53 in the turret loading apparatus 10 as well as for each of the seven further servos 64 to 70 in the machine 11. One of the electronic cams for the turret loading apparatus 10 is a feeder cam, which includes an electronic profile, shown at 75 in FIG. 11, that defines the motions of the feeding servo motor 53 driving the feeding device 52. The other of the electronic cams for the turret loading apparatus 10, a loading cam, includes a profile, shown at 77, that defines the accelerations, decelerations and dwell times of the loading servo motor 28. One of the further electronic cams for the machine 11 is a receiving or turret cam, which includes a profile, shown at 79, that defines motions of the turret servo motor 64 that indexes the turret 16. The cam profiles are illustrated for a so-called “double-indexing” machine 11 in which the turret 10 performs two indexes for each index of the main conveyor (not shown) of the machine. Each of the nine electronic cams programmed into the PLC 30, including the feeding, loading, and turret cams described above, follows the virtual time axis.

The feeding, loading, and turret cams are programmed so that the loading servo motor 28 is in dwell while the feeding device 52 is feeding, and so that the loading pusher 24 starts retracting before the turret 16 starts indexing. More specifically, once the feeding device 52 has finished moving a carton 12 from the magazine 51 to the load path 20 and opening the carton 12 into its open-ended rectilinear tube form, the PLC 30 commands the loading servo motor 28 to drive the loader chain 36 forwards in a “pre-load index” that moves the carton 12 to a pre-load position set by the loading cam.

In the pre-load position an optical pre-load detection sensor 71 confirms and reports the presence of a carton 12 to the PLC 30. If the sensor 66 detects a carton 12, the PLC 30 commands the loading servo motor 28 to reverse the loader chain 36 about 3 to 5 mm. and to dwell in that position while the PLC 30 commands the feeding servo motor 53 to cause the feeding device 52 to deposit a second partially-formed carton 12 on the load path behind the carton 12 in the pre-load position, while the turret servo motor 64 indexes (together with any immediately preceding carton thereon).

The PLC 30 then commands the loading servo motor 28 to drive the loader chain 36 forwards in a “load index” that moves the first carton 12 from the pre-load position to a loaded position on a turret mandrel 14 while moving the second carton 12 to the pre-load position. At this point the PLC 30, according to the loader cam, commands the loading servo motor 28 to reverse the loader chain 36 about 3 to 5 mm., so that the loading pusher 24 that pushed the first carton 12 into the loaded position is withdrawn from the path of the turret mandrels 14. The PLC 30 then, according to the turret cam, commands the turret servo motor 64 to index the turret 16. This, the normal operating mode of the machine 11, is called the “virtual mode” of operation.

The PLC 30 is also programmed to include, as a safety feature, an electronic clutch for each servo axis. The PLC 30 receives inputs from multiple sensors indicating product in tanks, temperature of heaters, fault status of various machine components, air pressure, vacuum, power, etc. The PLC 30 will allow the clutches to remain “engaged”, allowing the servos to operate, only if all of the sensor indications are positive, indicating that the machine 11 is ready to operate.

In addition, there are certain sensors that serve only to reset or disengage certain electronic clutches. For example, a pre-load detection sensor 71 in the form of a photo eye causes the loader clutch to reset if the pre-load sensor 71 fails to detect a carton 12 in the pre-load position when, according to the loader cam, a carton 12 should be in that position. Similarly, there is a similar post-feeding sensor 67 corresponding to a post-feeding position of a carton 12 on the conveyor 18 and a mounting sensor 69 corresponding to a mounting position of a carton 12 on the mandrel 14.

As an additional safety feature, should any of several safety circuits of the machine 11 be broken owing, for example, to a door being opened or an emergency stop switch pressed, the PLC 30 automatically takes the machine 11 from virtual mode to real mode by removing power from all of the servos, retracting all valves, disabling all of the electronic clutches, and stopping the virtual time axis. Going from virtual mode to real mode removes any possibility of the virtual time axis operating and causing a potentially unsafe situation or damaging equipment.

The PLC 30 in also programmed to include a homing mode that prepares the machine 11 to resume operation after the safety circuits are restored by, e.g., closing any open access doors and/or pressing a reset button. The machine 11 must be homed to align all components properly before returning to the virtual mode.

The machine 11 enters the homing mode either automatically once an operator restores the safety circuits while a key switch is in a run mode, or, if the key switch is in a maintenance mode, an operator must also go to a touch-screen of a human-machine interface (HMI) shown at 73 in FIG. 10, and touch a home button image on the screen of the HMI 73 to start the homing process.

The homing routine includes running the carton loading apparatus 10 in the forward direction and stopping when an optical homing detection sensor 72 sees a loading pusher 24 in a desired homing position. The PLC 30 then zeros out its homing position register and commands an offset from this position for each of the other eight servos of the machine 11. Each offset position is adjustable by manipulating a register in the PLC 30 through the HMI 73. Each offset generally remains the same but may change if, for example, the sensor position changes. The loading servo motor 28 has an encoder 74 that includes a battery back-up 76 to allow it to recall its position even following a power down or in other situations when power from a main power source 78 is unavailable.

Once every servo axis, turret servo motor 64, loading servo motor 28, etc. has completed homing, the PLC 30 returns automatically to virtual mode, ready to “spin.” A start button must then be pressed for three seconds before the virtual clock will start spinning again. The PLC 30 then checks all machine conditions as described above. Once the PLC 30 has provided an indication on the HMI 73 that the machine 11 is homed and ready, an operator must press a feeder start button to engage the electronic clutches in a predetermined sequence. The nine servo axes of the machine 11 then begin to operate in concert, following their respective electronic cam profiles, synchronized to the master virtual axis.

The turret loading apparatus described with reference to the drawings allows for a simpler loading pusher design and can more positively and accurately position cartons on turret mandrels.

We claim:

1.-30. (canceled)

31. Apparatus comprising a loading device including a loader for forwarding an article, a receiving device including a receiver for receiving said article delivered thereto by said loader, an advancing device arranged to advance said loader on an endless path, a driving device drivingly connected to said receiving device for advancing said receiver along a second path extending into the region of a portion of said endless path at which said loader delivers said article to said receiver, said advancing device being arranged to reverse said loader momentarily out of said region immediately following delivery of said article to said receiver.

32. Apparatus according to claim 31, wherein said delivering device is an endless conveyor, said loader is a pusher of said conveyor, and said receiving device comprises a series of mandrels one of which is said receiver, said article being a partially formed packaging carton receivable over said receiver.

33. Apparatus according to claim 32, wherein said receiving device is a rotatable turret which has said mandrels distribute therearound and which indexes said article through circumferentially spaced work stations, said pusher serving to propel said article along a load path and to load said article onto said receiver once the latter has been indexed into a position axially aligned with said load path, and said loading device including a loader guide arranged to maintain said article in axial alignment with said receiver during loading of said article onto said receiver.

34. Apparatus according to claim 33, in which said loader guide includes only two corner guides disposed in respective positions to guide diagonally opposite corners of said article.

35. Apparatus according to claim 33, and further comprising a controller arranged to command said advancing device to advance said conveyor and thereby transport said article along said load path and into a delivered position on said receiver and then to reverse said conveyor momentarily before said turret indexes, said article being an open-ended container of rectangularly tubular form.

36. Apparatus according to claim 35, and further comprising a feeding device arranged to feed said article to said loading device and a feeding servo motor arranged to drive said feeding device, and wherein said advancing device is a loading servo motor and said driving device is a receiving servo motor, said controller being programmed to synchronize operation of said loading servo motor with at least one of said receiving servo motor and said feeding servo motor.

37. Apparatus according to claim 36, wherein said controller has a virtual time axis to which the synchronized servo motors are slaved via respective electronic cams programmed into the controller.

38. Apparatus according to claim 36, wherein said controller is programmed to provide electronic cam profiles that define accelerations, decelerations, and dwells of the servo motors.

39. Apparatus according to claim 36, wherein said controller is programmed to provide electronic clutches arranged to terminate the operation of the servo motors in response to predetermined unacceptable sensor input values of any one or more parameters selected from the group consisting of air pressure, vacuum pressure, electrical power, fault status of various apparatus components, amount of product remaining in tanks, and heater temperatures.

40. Apparatus according to claim 36, and further comprising a pre-load detection sensor arranged to detect presence of said article in a pre-load position on said loading device, wherein said controller is programmed to include an electronic clutch arranged to preclude operating of said loading servo motor in response to an indication by said pre-load detection sensor that no article is present in said pre-load position.

41. Apparatus according to claim 36, wherein said controller has a virtual time axis to which the synchronized servo motors are slaved via respective electronic cams programmed into the controller, wherein said controller is programmed to provide electronic clutches arranged to terminate the operation of the servo motors in response to predetermined unacceptable sensor input values of any one or more parameters selected from the group consisting of air pressure, vacuum pressure, electrical power, fault status of various apparatus components, amount of product remaining in tanks, and heater temperatures, and wherein said controller is programmed to disable the electronic clutch(es), remove power from the servo motors, and stop the virtual time axis in response to a sensed dangerous condition or stop command.

42. Apparatus according to claim 36, and included in a container-forming machine which includes other devices which perform other functions and which are driven by respective other servo motors, said apparatus further comprising a homing detection sensor arranged to sense the presence of said loader in a desired homing position, wherein said controller is programmed to home said loading servo motor, said feeding servo motor and said receiving servo motor as well as said other servo motors by stopping the loading servo motor when forward running and when said homing detection sensor senses the presence of said loader in said desired homing position, and running said feeding servo motor and said receiving servo motor into predetermined positions offset relative to said loading servo motor.

43. Apparatus according to claim 36, and further comprising a feedback device which serves to inform said controller as to the position of said loading servo motor.

44. Apparatus according to claim 43, wherein said feedback device comprises an encoder connected to said controller, said apparatus further comprising a battery back-up connected to said encoder and arranged to power the encoder whenever a primary source of electrical power fails to provide power to the encoder.

45. Apparatus according to claim 36, wherein said apparatus further comprises a device which is connected to said loading servo motor and which is caused by said controller to emit a pulse chain to command the operation of said loading servo motor.

46. Apparatus according to claim 31, in which said loader comprises ultra-high molecular weight polyethylene.

47. A method comprising advancing a loader along an endless path into a region of which a second path extends and causing said loader to deliver an article to a receiver located on said second path at said region, momentarily reversing said loader out of said region immediately following the delivery of said article to said receiver, and advancing said receiver along said second path.

48. A method according to claim 47, wherein said article is a partially formed container which, when delivered by said loader, has thereby been received over said receiver which is in the form of a mandrel.

49. A method according to claim 47, and further comprising causing an appropriately programmed controller to command a loading servo motor to advance an endless conveyor until said loader which is carried by said conveyor has propelled said article along a load path and onto said receiver and to command said loading servo motor to reverse said conveyor once said loader has propelled said article onto said receiver.

50. A method according to claim 49, and further comprising causing the appropriately programmed controller to command said conveyor to start reversing and thereafter to command said receiver to advance along said second path.

51. A method according to claim 49, and further comprising feeding said article to said endless conveyor before propelling said article along said load path, and causing the appropriately programmed controller to synchronize the operation of said loading servo motor with at least one of a receiving servo motor and a feeding servo motor.

52. A method according to claim 51, and further comprising causing said controller to provide a virtual time axis and to enslave the servo motors to said virtual time axis via respective electronic cams programmed into the controller.

53. A method according to claim 51 and further comprising causing the appropriately programmed controller to home the servo motors by stopping the loading servo motor when it is running forwards and the presence of said loader in a desired homing position is detected and running said feeding servo motor and said receiving servo motor into predetermined positions offset relative to said desired homing position, and to home other servo motors of a container forming machine including said receiver, said loader, said loading servo motor, said controller, said feeding servo motor and said receiving servo motor.

54. A method according to claim 49, and further comprising causing the appropriately programmed controller to provide an electronic loader cam profile which defines accelerations, decelerations, and dwell times of said loading servo motor.

55. A method according to claim 49, and further comprising causing the appropriately said programmed controller to provide electronic clutches and utilizing said clutches to terminate the operation of the servo motors in response to predetermined unacceptable sensor input values of any one or more parameters selected from the group consisting of air pressure, vacuum pressure, electrical power, fault status of various machine components, amount of product remaining in tanks, and heater temperatures.

56. A method according to claim 49, and further comprising causing the appropriately programmed controller to provide an electronic clutch and utilizing said clutch to preclude operation of said loading servo motor in response to an indication that no carton is present in a pre-load position.

57. A method according to claim 49, and further comprising causing the appropriately programmed controller to disable the electronic clutch(es), remove power from the servo motor(s), and stop the virtual time axis in response to a sensed dangerous condition or stop command.

58. A method according to claim 49, and further comprising feeding back to said controller the position of said loading servo motor.

59. Apparatus comprising a loading device including a loader for forwarding an article, a receiving device including a receiver for receiving said article delivered thereto by said loader, an advancing device arranged to advance said loader on an endless path, a driving device drivingly connected to said receiving device for advancing said receiver along a second path extending into the region of a portion of said endless path at which said loader delivers said article to said receiver, and a controller connected to said advancing device and said driving device for controlling said advancing device and said driving device, said advancing device being a brushless servo motor with pulse train command by said controller and with encoded feedback to said controller as to the position of said brushless servo motor.

60. Apparatus according to claim 59, wherein a programme of said controller provides an electronic loading cam for controlling motion of said loading servo motor.
